(19) United States
(12) Patent Application Publication
(10) Pub. No.: US 2013/0312266 A1
(43) Pub. Date: Nov. 28, 2013

(54) Hand holdable device for sectioning of food

(71) Applicant: Erica E. Steinmann, Ridgefield, CT (US)

(72) Inventor: Erica E. Steinmann, Ridgefield, CT (US)

(21) Appl. No.: 13/986,643

(22) Filed: May 21, 2013

Related U.S. Application Data
(60) Provisional application No. 61/688,878, filed on May 24, 2012.

(51) Int. Cl. B26D 3/24

(52) U.S. Cl. CPC B26D 3/24
USPC 30/114

(57) ABSTRACT

A device for the sectioning of food piece(s)comprises: a tubular member, open at both opposed ends, which is small enough to be hand-holdable; a cutting element disposed adjacent a first open end of the tubular element, the cutting element being dimensioned to section such food piece(s)into an intended sectioned configuration; and a separate pusher member, which is configured to fit into the second open end of the tubular element after individual non-sectioned food piece(s)have been loaded into the tubular element, that can be pushed against the non-sectioned food piece(s)to force such piece(s)against and through the cutting element to produce the desired sectioned food.

This application claims the benefit of U.S. Provisional Application Ser. No. 61/688,878, filed May 24, 2012.

The present invention relates to a handholdable device that can be used to section a plurality of foods, for example, fruit and/or vegetable pieces or a frankfurter in one single operation. The device greatly simplifies the operation of appropriately sectioning one or more of such food pieces for consumption by a child of tender age who cannot safely ingest a larger food piece. Examples of fruits that can be processed in this device include, preferably non-pitted items, such as grapes and strawberries. In the case of a food such as a frankfurter, one frankfurter can be sectioned into smaller pieces, e.g., halves quarters or smaller that can be further subdivided by cutting perpendicular to the axis of such smaller pieces. In the case of placement of a plurality of fruit and/or vegetable pieces into the device, the device will, in many cases, subdivide this collection of food items into smaller pieces that can be directly ingested by the intended child.

The Drawings, which form part of the specification, are:

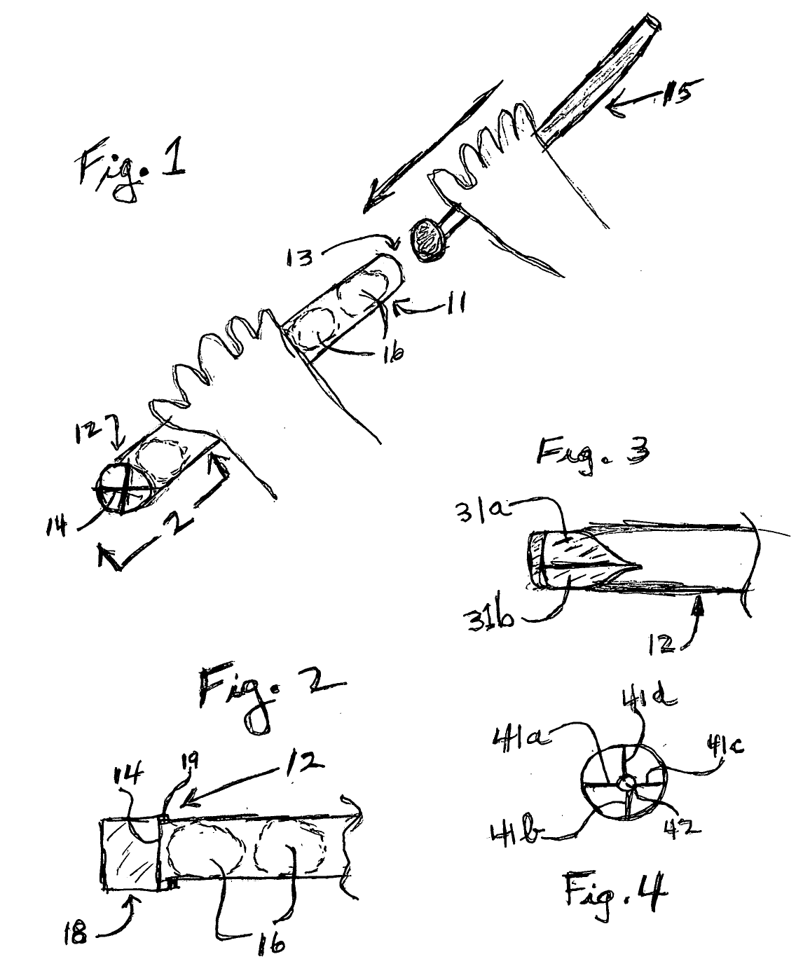

FIG. 1 which illustrates a perspective view of the invention as held for operation with the arrow illustrating the movement of one component in relation to the other;

FIG. 2 is a cross-sectional view, taken in the direction of arrows 2 in FIG. 1; and

FIGS. 3 and 4 are a side view and an end view, respectively of two cutting element designs, in addition to the cutting element design illustrated in FIG. 1, for use in accordance with the present invention.

FIG. 1 shows the device in operation in the case of sectioning a plurality of either fruit, such as grapes, and/or vegetables, such as cherry tomatoes. The device of this invention comprises: (a) a tubular member 11, which is small enough to be handholdable, and which is open at both opposed ends 12 and 13; (b) a cutting element 14, which can be interchangeable with cutting element(s) of differing configuration, fixedly disposed in the tubular member at, or immediately adjacent to, the first open end of that member, the cutting element being dimensioned to section the food pieces into their intended sectioned configuration (halves, quarters (such as illustrated in Fig.), or even smaller pieces); and (c) a separate pusher member 15, which is configured to fit into the second, opposed open end 13 of the tubular element after individual nonsectioned food pieces 16, shown in dotted line inside the member 13, have been loaded into member. In operation, one end 17 of pusher member 15, which is configured to snugly fit inside the cross-sectional area of member 13, is pushed against the non-sectioned food pieces to force them against the cutting element 14 thereby driving them in sectioned form through the other open end of the tubular element.

The diameter of tubular member 11 is only slightly larger than the diameter of the non-sectioned food pieces 16, but approximates such diameter in this fashion, so that if a plurality of such food pieces are loaded into the tubular member for cutting, they all line up in a generally straight line axially along the central axis of the tubular member.

FIG. 2 shows just one embodiment of the present invention in which food pieces 16 (e.g., grapes) are contained within the tubular member 12 of the device of this invention. The cutter 14 is placed on the end of a cap member 18 that, for safety purposes, is disposed at the end of such cap member immediately adjacent thread means 19 that join the cap member to the end of the tubular member 12. The cap member 18 can be appropriately color coded or labeled to designate either or both the type or size of food item to be cut when that member is secured and/or the type of subdivision that the cutter 14 will make on the unsectioned food item when it is pushed through the cutter.

FIGS. 3 and 4 illustrate certain cutting element designs. The one depicted in a side view in FIG. 3 has its blade members 31a and 31b in a tapering design stretching back into tubular member 12 (the other two similarly designed blades are not apparent in this side view since they are being viewed straight on). FIG. 4 is an end view of the cutting element alone with the four blades 41a-d designed to cut the food item into quarters. The central opening 42 is designed to let any centrally located pit in the food item pass through in the cutting operation.

I claim:

1. A device for the sectioning of at least one food piece comprising:
(a) a tubular member, which is small enough to be hand-holdable, and which is open at both opposed ends;
(b) a cutting element disposed adjacent a first open end of the tubular element at one end thereof, the cutting element being dimensioned to section such food piece or pieces into an intended sectioned configuration; and
(c) a separate pusher member, which is configured to fit into the second open end of the tubular element after individual nonsectioned food piece or pieces have been loaded into the tubular element, that can be pushed against the nonsectioned food piece or pieces to force it or them against the cutting element thereby driving it or them through the cutting element adjacent other open end of the tubular element to produced the desired sectioned food.
